(19) United States
(12) Patent Application Publication
(10) Pub. No.: US 2014/0122403 A1
(43) Pub. Date: May 1, 2014

(54) LOADING PREDICTION METHOD AND ELECTRONIC DEVICE USING THE SAME

(71) Applicants: INVENTEC (PUDONG) TECHNOLOGY CORPORATION, Shanghai (CN); INVENTEC CORPORATION, Taipei City (TW)

(72) Inventors: Bo-Wei Huang, Taipei City (TW); Kun-Wei Wang, Taipei City (TW); Wen-Chih Peng, Taipei City (TW); Chung-Chih Li, Taipei City (TW); Te-Yen Liu, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/846,767

(22) Filed: Mar. 18, 2013

(30) Foreign Application Priority Data
Oct. 31, 2012 (CN) 201210429377.X

(51) Int. Cl. G06N 5/02

(52) U.S. Cl. CPC G06N 5/02
USPC 706/45

(57) ABSTRACT

A loading prediction method, applicable to an electronic device, includes the following steps. Multiple resource loading records of the electronic device at multiple time periods are recorded, respectively. A predicted time point is received. A time difference between the predicted time point and a current time point is calculated. The predicted time point is greater than the current time point on a timeline. Whether the time difference is less than a threshold value is determined. A regression-based prediction according to the resource loading records is performed when the time difference is less than the threshold value. A clustering-based prediction according to the resource loading records is performed when the time difference is not less than the threshold value.

### CROSS-REFERENCE TO RELATED APPLICATIONS

This non-provisional application claims priority under 35 U.S.C. §119(a) on Patent Application No(s). 201210429377.X filed in China on Oct. 31st, 2012, the entire contents of which are hereby incorporated by reference.

### BACKGROUND OF THE DISCLOSURE

1. Technical Field of the Disclosure

This disclosure is related to a resource management technology, and more particularly to a loading prediction method and an electronic device using the same.

2. Description of the Related Art

Along with the advances in the computing ability of computers, an accumulation of large amounts of information occurs all the time, such as consuming behavior information of users, and information of road conditions and sensed data. With such large amounts of data, analyzing these data by use of cloud computing is becoming increasingly important.

Many cloud service providers with ability of cloud computing have come to market, such as the popular Amazon Elastic Compute Cloud (Amazon EC2). Amazon EC2 is a network service whose main function is to provide all sizes of computing services on a cloud computing platform and to provide a convenient computing environment for researchers and developers to perform large-scale computing.

However, the resource allocation techniques of the above-mentioned cloud computing platform system actually does not fully meet the needs of users; for example, the system resources cannot be fully used. Therefore, in order to enhance user satisfaction, as well as the overall operation performance of the cloud computing platform, a dynamic resource management mechanism is usually established, in order to efficiently allocate resources to all users.

The current resource management mechanism is achieved, for example, by loading prediction methods which include a regression analysis method and an artificial neural network (ANN) method. The regression analysis method applies a polynomial to find the closest data in historical data. The method needs a large storage space and system resources of the computer system because multidimensional data is needed for analysis and various data needs to be recorded for increasing accuracy. Moreover, for the ANN method, a prediction model is revised constantly, and the revised prediction model is needed for predicting the loading value of a next time point, thus it is not suitable for long-term loading prediction.

In conclusion, how to effectively allocate resources of a system has become one of the problems to be solved for developers.

### SUMMARY OF THE DISCLOSURE

An embodiment of the disclosure provides a loading prediction method, applicable to an electronic device, comprising the following steps. A plurality of resource loading records of the electronic device at a plurality of time periods are recorded, respectively. A predicted time point is received. A time difference between the predicted time point and a current time point is calculated. The predicted time point is greater than the current time point on a timeline. If it is determined that the time difference is less than a threshold value, a regression-based prediction according to the plurality of resource loading records is performed. A clustering-based prediction according to the plurality of resource loading records is performed when the time difference is not less than the threshold value.

Another embodiment of the disclosure provides an electronic device which comprises a recording module, a receiving module, a time calculating module, a regression analysis module, a cluster analysis module, and a determining module. The recording module is configured to record a plurality of resource loading records of an electronic device at a plurality of time periods, respectively. The receiving module is configured to receive a predicted time point. The time calculating module is configured to calculate a time difference between the predicted time point and a current time point. The predicted time point is greater than the current time point on a timeline. The regression analysis module is configured to perform a regression-based prediction according to the plurality of resource loading records. The cluster analysis module is configured to perform a clustering-based prediction according to the plurality of resource loading records. The determining module is configured to determine whether the time difference is less than threshold value. When the time difference is less than the threshold value, the determining module notifies the regression analysis module to perform the regression-based prediction. When the time difference is not less than the threshold value, the determining module notifies the cluster analysis module to perform the clustering-based prediction.

### BRIEF DESCRIPTION OF THE DRAWINGS

The disclosure will become more fully understood from the detailed description given herein below for illustration only, thus does not limit the disclosure, wherein:

FIG. 1 is a flow chart of a loading prediction method according to a first embodiment of the disclosure;

FIG. 2 is a flow chart of a cluster analysis prediction method according to a second embodiment of the disclosure;

FIG. 3 is a block diagram of an electronic device according to a third embodiment of the disclosure; and

FIG. 4 is a block diagram of a cluster analysis module according to the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

This disclosure provides a loading prediction method and an electronic device using the same, through which different predictions can be performed according to a time difference between a predicted time point and a current time point, thereby effectively predicting a plurality of resource loading records of the electronic device at the predicted time point. To make the contents of this disclosure easier to understand, the following embodiments are given as examples based on which this disclosure can be implemented.

### First Embodiment

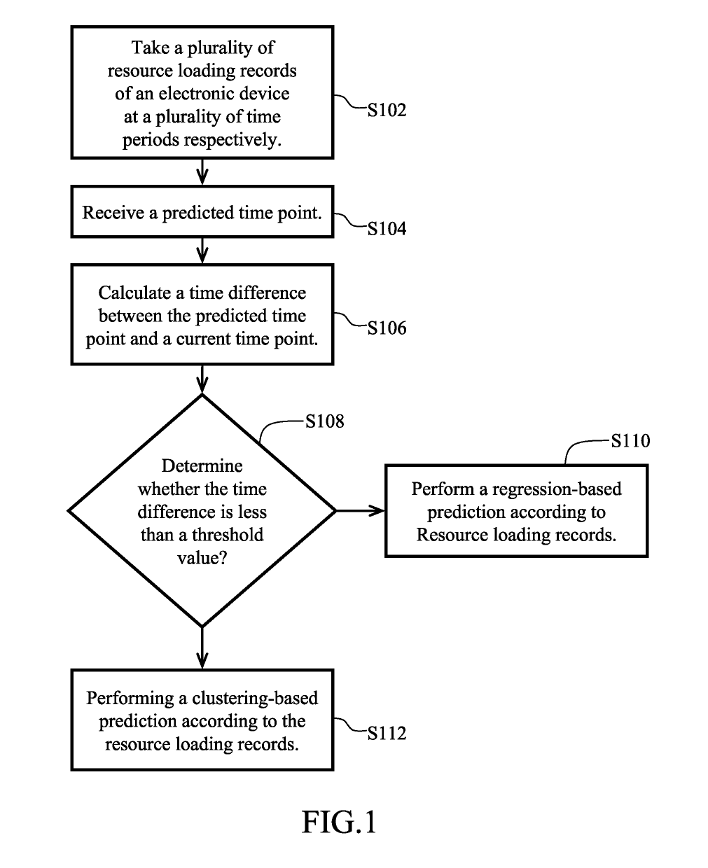

FIG. 1 is a flow chart of a loading prediction method according to a first embodiment of the disclosure. The loading prediction method of this embodiment is applicable to electronic devices. In this embodiment, the electronic device has a processing unit, which can be used for executing a plurality of code segments stored in a storage unit, to implement the steps of the loading prediction method as below.

Please refer to FIG. 1, in step S102, the processing unit records a plurality of resource loading records of the electronic device at a plurality of time periods respectively. Typically, the processing unit retrieves an amount of resource usage at each of the plurality of time points with an interval of d minutes (d is an integer) as a sampling rate. That is to say, each of the plurality of resource loading records includes a plurality of amounts of resource usages. For example, provided that the time period is 24 hours, and the processing unit acquires each of the plurality of resource loading records with an interval of 2 minutes, thus each of the resource loading records includes 720 amounts of resource usages.

In other words, the processing unit is configured to acquire the plurality of amounts of resource usages according to the sampling rate during each of the plurality of time periods, and then to record the plurality of amounts of resource usages as the plurality of resource loading records. That is to say, each of the plurality of time periods has a corresponding resource loading record. For example, given that the time period is 1 day (24 hours), a resource loading record will be recorded every day, i.e., the history record of the day.

Next, in step S104, the processing unit receives a predicted time point. The predicted time point is greater than a current time point on a timeline. Namely, the predicted time point is a point on the time line in the future or is farther away than the current time point from the original point of the timeline. Furthermore, in step S106, the processing unit calculates a time difference between the predicted time point and the current time point. In this embodiment, given that the predicted time point is 9am of May 19th, while the current time point is 7am of May 19th, the time difference is 2 hours.

Then, in step of S108, the processing unit determines whether the time difference is less than a threshold value. The processing unit is configured to set the threshold value according to user settings. When the time difference between the predicted time point and the current time point is less than the threshold value, step of S110 is performed. When the time difference is not less than the threshold value, the step of S112 is performed.

In step of S110, the processing unit performs a regression-based prediction according to the plurality of resource loading records. Typically, for the regression-based prediction, the processing unit is configured to use the plurality of resource loading records to perform a regression analysis algorithm to acquire a prediction model, so that the processing unit is configured to use this prediction model to predict the resource loading record of the electronic device at the predicted time point. For example, the regression analysis algorithm in statistics is used for acquiring the prediction module, i.e., finding out a function (a regression estimated equation) that best represents the all amounts of resource usages, and the function also represents the relation between the time and the resource. Therefore, both the predicted time point and the current time point are substituted into this prediction model (the regression estimated equation), so as to acquire a predicted value of the predicted time point, namely a predicted amount of resource usage.

When the time difference is not less than the threshold value, then, as shown in the step S112, the processing unit performs a clustering-based prediction according to the plurality of resource loading records. Typically, during the clustering-based prediction, the processing unit is configured to perform a cluster analysis on the plurality of resource loading records in the predicted time segment corresponding to the predicted time point, so as to divide the plurality of resource loading records of the predicted time segment into a plurality of clusters, and the processing unit is configured to select an average value of the cluster with the most counts from the plurality of clusters, to be used as the predicted value of the predicted time point.

Based on the above, the electronic device in this embodiment is configured to record the plurality of resource loading records of the electronic device at the plurality of time periods, so as to predict the amounts of resource usages for the electronic device at the predicted time point. In this embodiment, the amounts of resource usages for the electronic device at the predicted time point are predicted by one of the regression-based prediction and the clustering-based prediction, based on the time difference between the predicted time point and the current time point. When the predicted time point is close to the current time point (i.e., the time difference is less than the threshold value), the amount of resource usage is predicted by the regression-based prediction. Alternatively, when the predicted time point is not close to the current time point (i.e., the time difference is not less than the threshold value), the amount of resource usage is predicted by the clustering-based prediction. Therefore, the use conditions of resources for different application demands and operating environments are predicted according to the plurality of resource loading records, so as to effectively predict the value for the amounts of resource usages at the future point, thereby adjusting the resources use and allocation of the electronic device based on the predicted value. Moreover, the situation of loading imbalance is avoided in the electronic device, and a higher performance is achieved.

The following is another embodiment for a detailed description of the abovementioned cluster prediction.

### Second Embodiment

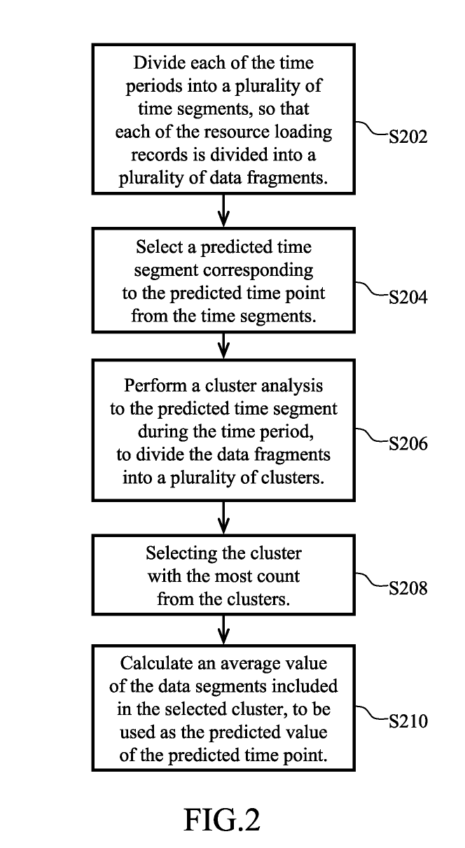

FIG. 2 is a flow chart of a cluster analysis prediction method according to a second embodiment of the disclosure. In this embodiment, an electronic device stores a plurality of resource loading records taken at a plurality of time periods, namely, each of the plurality of time periods has a corresponding resource loading record.

Please refer to FIG. 2, in the step of S202, a processing unit of the electronic device divides each of the plurality of time periods into a plurality of time segments, so that each resource loading record is divided into a plurality of data fragments. For example, provided that the time period is a day, and the processing unit divides the single day into 4 time segments, then each of the time segments is 6 hours, namely, the resource loading record of a day may be divided into four file fragments of 0:00-6:00, 6:00-12:00, 12:00-18:00 and 18:00-24:00. Provided that the sampling rate is 2 minutes, then each of the plurality of data fragments includes 180 amounts of resource usages. Furthermore, each of the plurality of time segments includes the plurality of data fragments of the plurality of time periods at this time segment. For 10 resource loading records, namely the historical records of 10 days, the time segment of 6:00-12:00 includes 10 data fragments, that is, the data fragments for 6:00-12:00 in 10 days. The rest are deduced by analogy.

Then, in step of S204, the processing unit selects a predicted time segment corresponding to the predicted time point from the plurality of predicted time segments. That is to say, the processing unit selects the time segment, including the predicted time point, as the predicted time segment.

After that, in step of S206, the processing unit performs a cluster analysis on the plurality of data fragments of the plurality of predicted time segments during the time period, to divide the plurality of data fragments into a plurality of clusters. Typically, when performing the cluster analysis, the processing unit calculates the distance sum among the plurality of resource loading records acquired at the same time point in the plurality of data fragments of each time segment, and then calculates a similarity among the plurality of data fragments of each time segment and divide the plurality of data fragments having a larger similarity into the same cluster. The processing unit uses, for example, Edit Distance on Real sequence (EDR) algorithm, Longest Common Subsequence (LCS) algorithm, Edit distance with Real Penalty (ERP) algorithm, or Dynamic Time Warping (DTW) algorithm to calculate the similarity, but is not limited to these algorithms. In this embodiment, the ERD algorithm is applied.

In addition, for example, the cluster analysis uses K-means clustering algorithm, Density-Based Spatial Clustering of Applications with Noise (DBScan), or Hierarchical clustering, so as to divide the plurality of data fragments in the plurality of time segments of each time period into a plurality of clusters. In this embodiment, the cluster analysis uses K-means clustering algorithm, but such a use is not intended to limit the disclosure.

Then, in step of S208, the processing unit selects the cluster with the most counts from the clusters. Furthermore, in step of S210, the processing unit calculates an average value of the plurality of data fragments included in the cluster which is selected, to be used as the predicted value of the predicted time point. Namely, the processing unit averages the plurality of resource loading records of the plurality of data fragments included in the cluster which is selected as well as calculating the average value of this cluster to be used as the resource loading record of the predicted time point.

For example, when there are 30 resource loading records, the time period is 1 day, and each day is divided into 6 time segments (0:00-4:00, 4:00-8:00, 8:00-12:00, 12:00-16:00, 16:00-20:00, 20:00-24:00). Given that the predicted time point is 3:00, then the selected predicted time segment is 0:00-4:00. Accordingly, the data fragments (30) of the predicted time segment 0:00-4:00 are retrieved from the 30 resource loading records, and a cluster analysis is then performed to these 30 data fragments. Given that the acquired cluster A, cluster B and cluster C respectively includes 10, 15 and 5 data fragments. Thus the cluster C having the 15 data fragments is retrieved. Next, the average value of the 15 data fragments of cluster C is calculated. Alternatively, only the average value of the cluster C at the predicted time point of 3:00 is calculated to be and taken as the predicted value.

Based on the above, this embodiment uses the plurality of resource loading records of the electronic device taken at the plurality of time periods, so as to predict the amounts of resource usages for the electronic device at the predicted time point. Moreover, when the predicted time point is not close to the current time point (i.e., the time difference is not less than the threshold value), the plurality of resource loading records are predicted through the clustering-based prediction, so as to select the average value of most of the plurality resource loading records to be as the predicted value of the resource loading record at the predicted time point. Accordingly, the method effectively predicts the value of the resource loading record at the future time point, and adjusts the resources use and allocation of the electronic device based on the predicted value, thereby improving the operating performance.

In light of the loading prediction method, this disclosure also provides a corresponding electronic device, such that the method can be applicable to PC, notebook computer, tablet computer, Personal Digital Assistant (PDA), server, cell phone and other hardware devices. The following is another embodiment for a detailed description.

### Third Embodiment

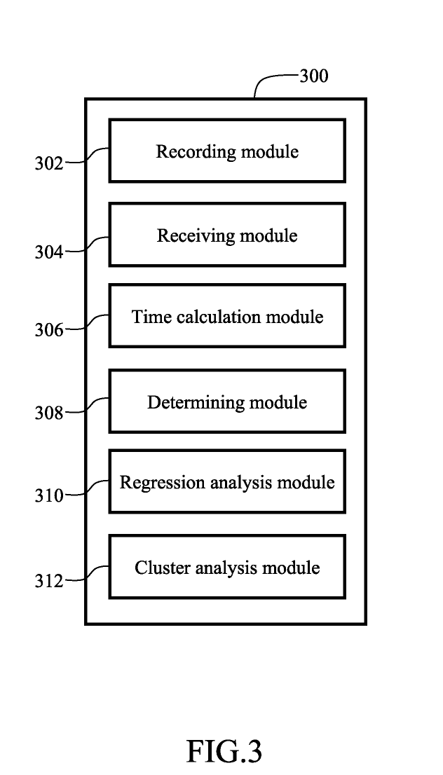

FIG. 3 is a block diagram of an electronic device according to a third embodiment of the disclosure. Please refer to FIG. 3, an electronic device 300 is, for example, a PC, a notebook computer, a tablet computer, a Personal Digital Assistant (PDA), a server, a cell phone, and other electronic devices, but this disclosure does not limit the variety of electronic device 300.

Please refer to FIG. 3, the electronic device 300 comprises a recording module 302, a receiving module 304, a time calculation module 306, a determining module 308, a regression analysis module 310, and a cluster analysis module 312. The functions of these modules are described hereinafter.

The recording module 302 is configured to record a plurality of resource loading records of the electronic device 300, namely, a plurality of historical records. The plurality of resource loading records are, for example, the usage rate of the Central Processing Unit (CPU), memory usage, the amount of usage of Page File (PF) or Network usage, but is not limited to the disclosure. Additionally, the recording module 302 is configured to record the resource loading records of the electronic device 300 according to a record time which is set by a user. For example, the record time is one or several week(s), one or several month(s), etc., but this embodiment does not limit the length of the record time. That is to say, the recording module 302 is configured to acquire different resource loading records according to use conditions of resources for different application demands and operating environments.

For example, when the electronic device 300 enters a sleep or a hibernate mode of Advanced Configuration and Power Interface (ACPI), the recording module 302 records a lower resource usage due to the electronic device 300 maintaining a lower operating performance. On the hand, when the electronic device 300 enters a normal operating mode, for example, when the electronic device 300 runs a software, applications or other executable programs, the recording module 302 records a higher resource usage due to the electronic device 300 maintaining a higher operating performance.

The receiving module 304 is configured to receive a predicted time point, which is greater than a current time point on a timeline. That is to say, this embodiment may predict resource usage of the electronic device 300 at this predicted time point. Additionally, the receiving module 304 may use the time point, set by the user, as the predicted time point.

The time calculation module 306, coupled to the receiving module 304, is configured to calculate a time difference between the predicted time point and the current time point. For example, the time calculation module 306 performs a subtraction between the predicted time point and the current time point, so as to acquire the time difference.

The determining module 308, coupled to the time calculation module 306, is configured to compare the time difference acquired from the time calculation module 306 with a threshold value so as to determine whether the time difference is less than the threshold value. The determining module 308 may determine according to the threshold value which is set by the user.

The regression analysis module 310 is coupled to the determining module 308 and the recording module 302. In this embodiment, the regression analysis module 310 is configured to perform a regression-based prediction according to the plurality of resource loading records taken by the recording module 302. Typically, during the regression-based prediction, the regression analysis module 310 performs a regression analysis algorithm for the resource loading records taken by the recording module 302 during the time period, so as to acquire a prediction model, thereby retrieving the predicted value corresponding to the predicted time point from the prediction model.

The cluster analysis module 312 is configured to perform a clustering-based prediction according to the plurality of resource loading records. Typically, during the clustering-based prediction, the cluster analysis module 312 selects an average value of most of the plurality of resource loading records to be as the predicted value of the plurality of resource loading records at the predicted time point in the predicted time segment corresponding to the predicted time point.

In this embodiment, the recording module 302, the receiving module 304, the time calculation module 306, the determining module 308, the regression analysis module 310 and the cluster analysis module 312 of this embodiment are respectively implemented by a hardware circuit consisting of one or several logical gate(s).

Moreover, in another embodiment of this disclosure, the recording module 302, the receiving module 304, the time calculation module 306, the determining module 308, the regression analysis module 310 and the cluster analysis module 312 are implemented by computer program codes. For example, the recording module 302, the receiving module 304, the time calculation module 306, the determining module 308, the regression analysis module 310 and the cluster analysis module 312 are implemented by a plurality of code segments written with program language upon applications, operating system or drivers, and these code segments are stored in and executed by a storage unit.

Moreover, in other embodiments, the electronic device 300 further comprises a processing unit and a storage unit. The processing unit is coupled to the recording module 302, the receiving module 304, the time calculation module 306, the determining module 308, the regression analysis module 310 and the cluster analysis module 312 respectively, so as to drive these modules. The above-mentioned modules implemented by the assist of the processing unit.

Furthermore, the processing unit is hardware (e.g., chip set and processor) with operational capability, configured to control the overall operation of the electronic device 300. For example, the processing unit is, a Central Processing Unit (CPU), other programmable microprocessors, a Digital Signal Processor (DSP), a programmable controller, an Application Specific Integrated Circuits (ASIC), a Programmable Logic Device (PLD), or other similar devices.

In addition, the storage unit may be an embedded storage unit or an external storage unit. The embedded storage unit may be Random Access Memory (Ram), Read-Only Memory (ROM), flash memory, or magnetic disk storage device. The external storage unit may be Compact Flash (CF), Secure Digital (SD) card, Micro Secure Digital (Micro SD) card, or Memory Stick (MS). In this embodiment, the storage unit stores one or more program codes and data for executing the loading prediction method (e.g., the plurality of resource loading records and the threshold value taken by the recording module 302).

In order to make persons skilled in this art further understand the loading prediction method and the electronic apparatus using the same of this embodiment, the following examples are given for a detailed explanation of the cluster analysis module 312.

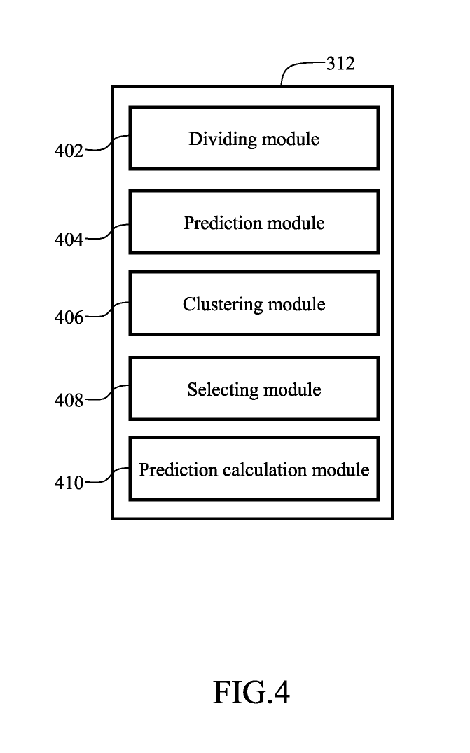

FIG. 4 is a block diagram of a cluster analysis module according to the third embodiment of the disclosure. Please refer to FIG. 4, the cluster analysis module 312 comprises a dividing module 402, a prediction module 404, a clustering module 406, a selecting module 408, and a prediction calculation module 410. The module functions of the cluster analysis module 312 are described as follows.

The dividing module 402 is configured to execute the step 5202, that is, to divide each of the plurality of time periods into a plurality of time segments, thereby dividing the plurality of resource loading records of each time period into a plurality of data fragments. The prediction module 404 is configured to execute the step S204, that is, selecting the time segment consistent with the predicted time point from the time period. The clustering module 406 is configured to execute the step S206, that is, operation of cluster analysis. The selecting module 408 is configured to execute the step S208, that is, selecting one from the clusters. The prediction calculation module 410 is configured to execute the step S210, calculating the average value of the plurality of resources loading records.

In addition, the dividing module 402, the prediction module 404, the clustering module 406, the selecting module 408 and the prediction calculation module 410 may also be program codes written with program language or independent chip. The detailed descriptions for the dividing module 402, the prediction module 404, the clustering module 406, the selecting module 408 and the prediction calculation module 410 are with reference to FIG. 2, it is unnecessary to repeated herein.

### Fourth Embodiment

In order to make persons skilled in this art further understand the loading prediction method and the electronic apparatus using the same of this embodiment, another example is given for explanation, also combined with the electronic device 300 of FIG. 3.

In this embodiment, given that the recording module 302 takes one day as a time period, the amount of resource usage is recorded once every 2 minutes, and 14 amounts of usage of the electronic device 300 from May 1st to May 14th are recorded. That is to say, the recording module 302 records 10080 amounts of the resource usages during the 14 time periods (indicated by T1-T14 hereinafter).

Given that the predicted time point received by the receiving module 304 is 9am of May 5th, while the current time point is 8am of May 15th, and the threshold value is 2 hours. Then, the determining module 308 determines whether the time difference (i.e., 1 hour) between the predicted time point (9am of May 5th) and the current time point (8am of May 15th) is less than the threshold value or not. The determining result from the determining module 308 is that the time difference between the predicted time point and the current time point is less than the threshold value, thus the regression analysis module 310 performs the regression-based prediction according to the 10080 amounts of the resource usages of the electronic device 300 from May 1st to May 14th.

In this embodiment, during the regression-based prediction, the regression analysis module 310 performs a regression analysis algorithm according to the 10080 amounts of the resource usages, to acquire a prediction model. The prediction model comprises the plurality of predicted values corresponding to the plurality of time points (i.e., every 2 minutes) from the current time point (8 am of May 15th) to the predicted time point (9 am of May 5th). That is to say, the regression analysis module 310 substitutes the predicted time point (9 am of May 5th) into the prediction model, so as to retrieve the predicted value corresponding to the predicted time point to be as the predicted amount of the resource usage.

In this embodiment, the predicted time point is close to the current time point (i.e., the time difference is less than the threshold value), thus the electronic device 300 will predict the amount of resource usage via the regression-based prediction, thereby effectively predicting the value of amount of resource usage at the future time point.

On the other hand, in this embodiment, given that the predicted time point received by the receiving module 304 is 10 am of May 5th, while the current time point is 6 am of May 15th, and the threshold value is 2 hours. The determining module 308 determines whether the time difference (i.e., 3 hours) between the predicted time point (10 am of May 5th) and the current time point (6 am of May 15th) is less than the threshold value. The determining result from the determining module 308 is that the time difference between the predicted time point and the current time point is not less than the threshold value, thus the cluster analysis module 312 performs the clustering-based prediction according to the 10080 amounts of the resource usages of the electronic device 300 from May 1st to May 14th.

Typically, during the regression-based prediction, the dividing module 402 divides the plurality of time periods T1-T14 into a plurality of time segments, so as to divide the plurality of resource loading records of the plurality of time periods T1-T14 into a plurality of data fragments.

In this embodiment the dividing module 402 is assumed to divide the time periods T1-T14 into 4 time segments (indicated by TS1-TS4 hereinafter). That is, each of the time periods (i.e., one day) is divided into 4 time segments by the dividing module 402. Each of the plurality of time segments is 6 hours. Typically, for each time period, the time segment from midnight to 6 am is TS1, that from 6 am to 12 noon is TS2, that from 12 noon to 6 pm is TS3, and that from 6 pm to midnight is TS4.

Then, the prediction module 404 selects a predicted time segment corresponding to the predicted time point from the plurality of time segments TS1-TS4. Because the predicted time point 10 am of May 15th belongs to the time segment S2, the prediction module 404 selects the time segment S2 as the predicted time segment (indicated by Q hereinafter).

Furthermore, the clustering module 406 performs a cluster analysis on the plurality data fragments of the predicted time segment Q recorded by the recording module 302 during the plurality of time periods T1-T14. Given that the clustering module 406 divides the plurality of file fragments into 5 clusters (indicated by C1-C hereinafter) through K-means cluster analysis, and the cluster C3 has the data fragments with the most counts, the selecting module 408 selects the cluster C3 from the clusters C1-C5. Then, the prediction calculation module 410 calculates the average value of the data fragments of cluster C3 included in the plurality of time periods T1-T14, to be as the predicted value of the predicted time point (9am of May 15), so that the predicted value serves as the predicted amount of the resource usage.

In this embodiment, the distance from the predicted time point to the current time point is longer (namely, the time difference is not less than the threshold value), thus the electronic device 300 predicts the amount of resource usages via the clustering-based prediction, in order to select the average value of most amounts of the resource usages to be as the predicted value of amounts of resource usages at the predicted time point. In this way, the electronic device 300 may effectively predict the amount of resource usages at the future time point based on the predicted value.

As a consequence of the above, the loading prediction method and the electronic device are provided in the embodiments of this disclosure. The electronic device predicts the amount of resource usages by a plurality of resource loading records taken in a plurality of time periods. When the time difference between the predicted time point and the current time point is less than the threshold value, the electronic device predicts the amount of the resource usages via the regression-based prediction. On the other hand, when the time difference between the predicted time point and the current time point is less than the threshold value, the electronic device predicts the amount of the resource usages via the clustering-based prediction. Therefore, the electronic device may predict the use conditions of resources for different application demands and operating environments according to the resource loading records. In this way, the electronic device adjusts the use and allocation of resources based on the predicted value, thus improving the operating performance.

What is claimed is:

1. A loading prediction method, applicable to an electronic device, the method comprising:
recording a plurality of resource loading records of the electronic device at a plurality of time periods, respectively;
receiving a predicted time point;
calculating a time difference between the predicted time point and a current time point, and wherein the predicted time point is greater than the current time point on a timeline;
determining whether the time difference is less than a threshold value;
performing a regression-based prediction according to the plurality of resource loading records when the time difference is less than the threshold value; and
performing a clustering-based prediction according to the plurality of resource loading records when the time difference is not less than the threshold value.

2. The loading prediction method according to claim 1, wherein the step of performing a regression-based prediction according to the plurality of resource loading records further comprises:
performing a regression analysis algorithm for the plurality of resource loading records to acquire the prediction model; and
retrieving a predicted value corresponding to the predicted time point in the prediction model.

3. The loading prediction method according to claim 1, wherein the step of performing a clustering-based prediction according to the plurality of resource loading records further comprises:
dividing each of the plurality of time periods into a plurality of time segments, so that each of the plurality of resource loading records is divided into a plurality of data fragments;
selecting a predicted time segment corresponding to the predicted time point from the time segments;
performing a cluster analysis on the plurality data fragments in the predicted time segment of the plurality of time periods, to divide the plurality of data fragments into a plurality of clusters;
selecting one of the plurality of clusters with the most counts from the plurality of clusters; and
calculating an average value of the plurality of data segments included in the cluster which is selected, to be used as the predicted value of the predicted time point.

4. The loading prediction method according to claim 3, wherein the step of performing a cluster analysis to the predicted time segment during the time period further comprises:
calculating a similarity among the plurality of data segments of each of the plurality of time segments, and performing a cluster analysis according to the similarity.

5. The loading prediction method according to claim 1, wherein the step of recording the plurality of resource loading records of the electronic device at the plurality of time periods respectively further comprises:
acquiring a plurality of amounts of resource usage according to a sampling rate during each of the plurality of time periods, and wherein each of the plurality of resource loading records includes the plurality of amounts of resource usage during each of the plurality of time periods.

6. An electronic device, comprising:
a recording module configured to record a plurality of resource loading records of an electronic device at a plurality of time periods, respectively;
a receiving module configured to receive a predicted time point;
a time calculating module configured to calculate a time difference between the predicted time point and a current time point, and wherein the predicted time point is greater than the current time point on a timeline;
a regression analysis module configured to perform a regression-based prediction according to the plurality of resource loading records;
a cluster analysis module configured to perform a clustering-based prediction according to the plurality of resource loading records; and
a determining module configured to determine whether the time difference is less than threshold value, and wherein, when the time difference is less than the threshold value, the determining module notifies the regression analysis module to perform the regression-based prediction, and when the time difference is not less than the threshold value, the determining module notifies the cluster analysis module to perform the clustering-based prediction.

7. The electronic device according to claim 6, wherein the regression analysis module is configured to perform a regression analysis algorithm for the plurality of resource loading records to acquire the prediction model, the regression analysis module is configured to retrieve a predicted value corresponding to the predicted time point in the prediction model, and the plurality of resource loading records are recorded by the recording module respectively during the plurality of time periods.

8. The electronic device according to claim 6, wherein the cluster analysis module further comprises:
a dividing module configured to divide each of the plurality of time periods into a plurality of time segments, so that each of the plurality of resource loading records is divided into a plurality of data fragments;
a prediction module configured to select a predicted time segment corresponding to the predicted time point from the plurality of time segments;
a clustering module configured to perform a cluster analysis on the data fragments in the predicted time segment of the plurality of time periods, to divide the plurality of data fragments into a plurality of clusters;
a selecting module configured to select one of the plurality of clusters with the most counts from the plurality of clusters; and
a prediction calculation module configured to calculate an average value of the plurality of data segments included in the cluster which is selected, to be used as the predicted value of the predicted time point.

9. The electronic device according to claim 8, wherein the clustering module is configured to calculate a similarity among the plurality of data segments of each of the plurality of time segments, and is configured to perform a cluster analysis according to the similarity.

10. The electronic device according to claim 6, wherein the recording module is configured to acquire a plurality of amounts of resource usage according to a sampling rate during each of the plurality of time periods, and wherein each of the plurality of resource loading records includes the amounts of the resource usage during each of the plurality of time periods.
